(19) United States
(12) Patent Application Publication
(10) Pub. No.: US 2026/0166870 A1
(43) Pub. Date: Jun. 18, 2026

(54) Very thin electronic packaging leather and preparation method thereof

(71) Applicant: Zhejiang Hexin New Material Co., Ltd., Jiaxing City (CN)

(72) Inventors: Lili Xu, Jiaxing City (CN); Xuefeng YAN, Jiaxing City (CN); Hao WU, Jiaxing City (CN); Pengfei FU, Jiaxing City (CN); Yong CHEN, Jiaxing City (CN); Qian CHEN, Jiaxing City (CN); Bin HONG, Jiaxing City (CN)

(73) Assignee: Zhejiang Hexin New Material Co., Ltd., Jiaxing City (CN)

(21) Appl. No.: 19/023,122

(22) Filed: Jan. 15, 2025

(30) Foreign Application Priority Data
Dec. 16, 2024 (CN) 2024118539814

(51) Int. Cl. B32B 37/00; B32B 5/02; B32B 27/12; B32B 27/40; B32B 37/12; B32B 38/00; C09J 5/06; C09J 11/04; C09J 175/08; D06N 3/00; D06N 3/14; D06P 5/20; D06P 7/00

(52) U.S. Cl. CPC B32B 37/025; B32B 5/024; B32B 27/12; B32B 27/40; B32B 37/12; B32B 38/145; C09J 5/06; C09J 11/04; C09J 175/08; D06N 3/0006; D06N 3/0027; D06N 3/0097; D06N 3/14; D06P 5/2077; D06P 7/00; B32B 2255/10; B32B 2255/26; B32B 2262/0215; B32B 2305/188; B32B 2307/7376; B32B 2457/00; B32B 2571/00; D06N 2201/0209; D06N 2205/023; D06N 2211/00

(57) ABSTRACT

The present invention relates to the technical field of packaging leathers, specifically a very thin electronic packaging leather and preparation method thereof. In the present invention, by attaching a dry PU coating on a very thin woven fabric and using the polycarbonate resin which is solvent free, requirements on high physical performance phone cases are satisfied, in the meanwhile, the phones are light-weighted, and protection performance of the entire phones is improved. By printing a layer of organic silicone antifouling coating, while the texture is smooth and nice, the pollution cleaning and chemical resistance requirements for phones in daily use have been satisfied.

### INCORPORATION BY REFERENCE

This application claims the benefit of priority from China Patent Application No. 2024118539814 filed on Dec. 16, 2024, the contents of which are hereby incorporated by reference in their entirety.

### TECHNICAL FIELD

The present invention relates to the technical field of packaging leathers, relates to a very thin electronic packaging leather and preparation method thereof.

### BACKGROUND TECHNOLOGY

With the rapid development of the electronic industry, demands for packaging leathers for electronic products such as telephone cases, tablet computer cases and keyboard protection cases are increasingly vigorous. At present, main brands such as Huawei, Xiaomi, Honor, OPPO, vivo etc. released vegan leather covered phones, such kind of product has advantages of being soft in texture, of a low self-weight and low signal disturbance. However, the electronic packaging leather in the prior art is usually very thick, which goes against the electronic product development trend of going thinner and thinner.

The electronic packaging leather in the prior art has primarily the following defects: 1. The product thickness is high, which cannot satisfy demands of electronic product going light and thin; 2. During preparation of the electronic packaging leather, usually organic solvents such as N,N-dimethylformamide and catalyst such as organic tins are used, which are poisonous to human bodies and the environment; 3. Antifouling performance is not good enough, and it is difficult to satisfy the cleaning requirements during daily use.

### SUMMARY OF THE INVENTION

The present invention aims to provide a very thin electronic packaging leather and preparation method thereof, to address the problem that the thickness of the electronic packaging leather is very high, the preparation process is not environment friendly, and the antifouling performance is not satisfactory.

The technical solution employed to address the technical problem is that:
A preparation method of very thin electronic packaging leather, the method comprises the following steps:
S1: foundation fabric preparation: using terylene-elastane mixed dense plain woven butterfly mesh fabric as a foundation fabric layer, wherein terylene having a weight percentage of 75%-90% and elastane having a weight percentage of 10%-25%;
S2: coating a surface layer sizing agent on a surface of a release paper, heating, drying, and obtaining a surface layer of the packaging leather; coating an intermediate layer sizing agent over the surface layer, heating, drying, and obtaining an intermediate layer of the packaging leather;
S3: laminating the foundation fabric layer with the intermediate layer via an adhesive layer;
Applying an agent of the adhesive layer on the intermediate layer of the packaging leather, and attaching the foundation fabric layer before the agent is dried;
S4: curing the foundation fabric layer and the release paper in a 135° C. drying oven for 10-20 min, taking out, releasing and obtaining a PU/very thin woven fabric laminated material packaging leather;
S5: gravure printing antifouling coating on a surface of the PU/very thin woven fabric laminated material packaging leather, a coating amount is 20-30 g/m², drying and curing at a temperature of 170° C.±10° C. to form an antifouling coating, and obtaining a very thin electronic packaging leather product.

In the present invention, by applying a PU in a dry manner over the very thin woven fabric, by combination of polycarbonate resin which is solvent free, requirements of phone cases on high physical performance is satisfied, in the meanwhile, the phone is light-weighted, and the protection of the telephone is improved. By printing a layer of organic silicone antifouling layer, the texture is soft and smooth, while cleaning of most dirt and chemical corrosion resistance performance of the phone in daily life is met. From the perspective of environment protection, use organic solvents such as N,N-dimethylformamide and catalyst such as organic tins which are harmful to human bodies is avoided.

Preferably, the very thin woven fabric comprises a specification of terylene and elastane (30D+20D*30D+20D) or (20D+15D*20D+15D), weight 40-60 gsm, and thickness 0.08-0.1 mm; a thickness of the very thin electronic packaging leather product is 0.15-0.25 mm. As a special very thin foundation fabric is used, the packaging leather obtained as per the process in the present invention can satisfy the requirements of electronic products being very thin.

The specification of the erylene and elastane (30D+20D*30D+20D) or (20D+15D*20D+15D) comprises terylene yarn 30 D with a yarn fineness of 30 denier, elastane yarn 20D with a yarn fineness of 20 denier; 30D+20D*30D+20D: a material of a warp direction yarn is 30D terylene and 20D elastane, and so is a weft direction yarn; (20D+15D*20D+15D) is similar.

Preferably, the surface layer sizing agent comprises following elements in parts by weight: anionic aliphatic aqueous hydroxy-functional polyurethane dispersions 100 parts, a defoaming agent 0.01-0.2 parts, a cross-linking agent 0.1-3 parts, a thickening agent 0.1-3 parts, a flatting agent 0.1-2 parts, an organic silicone wear resistant feeling agent 0.1-3 parts, color sizing 1-15 parts, wherein a solid content of the anionic aliphatic aqueous hydroxy-functional polyurethane dispersions is 35-45%, a viscosity of the surface layer sizing agent is 1000-10000 cps/25° C. and a coating amount is 100-300 g/m²;

Preparation of the surface layer sizing agent: adding the organic silicone wear resistant feeling agent, the flatting agent and the color sizing into the anionic aliphatic aqueous hydroxyl-functional polyurethane dispersions, stirring, adding the defoaming agent, adding the thickening agent to adjust to an appropriate viscosity, stirring to disperse uniformly, adding the cross-linking agent before fabrication, stirring gently, filtering and vacuum defoaming.

Preferably, the intermediate layer sizing agent comprises the following elements in parts by weight: anionic aliphatic aqueous polyurethane dispersions 100 parts, a defoaming agent 0.01-0.2 parts, a flatting agent 0.1-2 parts, a thickening agent 0.1-3 parts, coloring sizing 10-30 parts, wherein a solid content of the anionic aliphatic aqueous polyurethane dispersions is 30-60%, a viscosity of the intermediate layer sizing agent is 1000-10000 cps/25° C. and a coating amount is 100-300 g/m²;
Preparation of the intermediate layer sizing agent: adding the flatting agent and the color sizing in the anionic aliphatic aqueous polyurethane dispersions, stirring, adding the defoaming agent, dispersing completely, adding the thickening agent to adjust to an appropriate viscosity, filtering and vacuum defoaming.

Preferably, the agent of the adhesive layer comprises the following elements in parts by weight: polyether urethane 100 parts, dibutyltin dilaurate esters 0.1-1 parts, isocaprylic acid bismuth 0.1-1 parts, isocyanate-capped polyurethane prepolymers 100-140 parts, filling agents 5-30 parts, with a viscosity of 2000-10000 cps/25° C. and a coating amount of 100-300 g/m²; the filling agent is selected from any one or two or combination of matting powder, aluminum hydroxide, aluminum oxide, magnesium hydroxide, zinc borate, aluminum silicate, magnesium carbonate, glass microspheres, white carbon black, silicone resin powder, silicon dioxide, calcium carbonate or magnesium oxide;
Preparation of the agent of the adhesive layer: taking the polyether urethane 100 parts, adding the filling agent, the dibutyltin dilaurate esters and the isocaprylic acid bismuth, stirring evenly, and obtaining a solvent free adhesive layer resin; mixing the polyether urethane (part A of isocyanate) and the isocyanate-capped polyurethane prepolymers (part B of isocyanate), stirring quickly and obtaining the agent of the adhesive layer.

Preferably, the antifouling coating comprises the following elements in parts by weight: organic silicone modified polyurethane resin 100 parts, high-silicon modified aqueous polyurethane resin 5-30 parts, acid catalysts 0.1-10 parts, isocyanate cross-linking agents 0.1-5 part; and a viscosity of the antifouling coating is 600-800 cps/23° C.

Preferably, in the antifouling coating, platinum catalyst is selected from any one or combination of platinic chloride-divinyl-tetramethyldisiloxane composition, platinic chloride-1,3,5,7-tetravinyl-1,3,5,7-tetramethyl-cyclotetrasiloxane, or divinyl-tetramethyldisiloxane, and a Pt (platinum) atom content in the platinum catalyst is 300-100000 ppm.

Preferably, S5: gravure printing the antifouling coating on the surface of the PU/very thin woven fabric laminated material packaging leather, wherein a first layer of the antifouling coating comprises the following components in parts by weight: organic silicone modified polyurethane resin 100 parts, high-silicon modified aqueous polyurethane resin 5-30 parts, acid catalyst 0.1-10 parts, and isocyanate cross-linking agent 0.1-5 parts; a viscosity of the antifouling coating is 600-800 cps/23° C.; a second layer of the antifouling coating comprises the following components in parts by weight: epoxy-modified organic silicone resin 100 parts, platinum catalysts 0.1-2 parts, and accelerating agents 0.1-5 parts and a viscosity of the antifouling coating is 600-800 cps/23° C.

Preferably, the first layer of the antifouling coating comprises the following components in parts by weight: organic silicone modified polyurethane resin (a solid content of 3%) 100 parts, high-silicon modified aqueous polyurethane resin 15 parts, acid catalyst 2 parts, and isocyanate cross-linking agent 2 parts, adjusting the viscosity to 700 cps/23° C. and a coating amount of 25 g/m²; the second layer of the antifouling coating comprises the following components in parts by weight: epoxy-modified organic silicone resin 100 parts, platinum catalysts 0.5 parts, accelerating agents 2 parts, and propanediol 20 parts, adjusting the viscosity to 700 cps/23° C. and a coating amount of 25 g/m².

Auxiliary agents in the present invention, comprising the flatting agent, the thickening agent, the defoaming agent, the cross-linking agent, the platinum catlaysts, the organic wear resistant feeling agent fall into conventional choices, which those skilled in the art can select as per actual conditions. For example, the flatting agent comprises preferably organic silicone modified polyester aqueous flatting agent such as BYK-346, BYK-348 and the defoaming agent comprises preferably organic silicone modified foaming suppressors such as BYK-024, BYK-054.

A very thin electronic packaging leather obtained by using the method according to the present invention, wherein the very thin electronic packaging leather comprises a foundation fabric layer, an adhesive layer, an intermediate layer, a surface layer and an antifouling coating.

Compared with the prior art, the present invention has the following beneficial effects:
1. In the present invention, a very thin woven fabric is used as a substrate of the very thin electronic packaging leather, the product thickness can be controlled to be in a range of 0.15-0.25 mm, and the light weight requirements of electronic products especially phones can be promised;
2. In the present invention, by using the aqueous polyurethane resin and the solvent free system, use of poisonous organic solvents such as DMF can be avoided, and the preparation process is more environment friendly;
3. In the present invention, by gravure printing the antifouling coating on the product surface, the pollution resistant performance and wear resistant performance of the product is improved, and the product has excellent cleaning properties and durability; and
4. In the present invention, the very thin electronic packaging leather has excellent physical performance, comprising high tensile load, moderate elongation at break, good tearing strength and peeling strength, and significant wear resistance, pollution resistance and aging resistance performance.

### EMBODIMENTS

Hereinafter a further description will be given to the technical solution of the present invention by means of some embodiments. It shall be understood that, the implementation of the present invention is not limited to the following embodiments, and any form of changes and/or modifications to the present invention shall fall into the protection scope of the present invention.

In the present invention, unless indicated specifically, all the percentages and percent are weight units, and the device and material used are commercially available or commonly seen in the field. The methods in the following embodiments, unless indicated expressly otherwise, comprise conventional method available in the industry.

The reagents used in the embodiments, unless specifically noted, were purchased from conventional chemical and biological reagent stores.

Aqueous polyurethane surface layer resin, and anionic aliphatic aqueous hydroxy-functional polyurethane dispersions were purchased from Wanhua Chemical Crysol® 6512;

The aqueous polyurethane intermediate layer resin, anionic aliphatic aqueous polyurethane dispersions were purchased from Wanhua Chemical Crysol® 6110;

The adhesive layer resin, the polyester urethane, model XCNS-3015A, were purchased from Xuchuan Chemical (Suzhou) Co., Ltd;
The isocyanate-capped polyurethane prepolymers, solid content 100%, mode 3015B, were purchased from Xuchuan Chemical (Suzhou) Co., Ltd;
The epoxy modified organic silicone resin, model SH-023, Hubei LSSH New Materials Co., Ltd.;
The defoaming agent, BYK additive BYK-024; the cross-linking agent, Wanhua Chemical Aquolin® 161; the thickening agent, Wanhua Chemical U605A; the flattening agent, BYK-346; the organic silicone wear resistant feeling agent, Silok® 51; the filling agent, calcium carbonate, Meryer; The organic modified polyurethane resin, Silok Dolphin 1090R2 silicone PUD resin;
The high-silicon aqueous polyurethane resin, Silok Dolphin 1089R3 resin; The acid catalysts, neodecanoic acid bimuth Deyin Chemical;
The platinum catalysts,
The accelerating agent, the aqueous closed isocyanate, Silok WinWin BL-6640.

The core of the present invention is to claim protection for a very thin electronic packaging leather, comprising a foundation fabric layer, an adhesive layer, an intermediate layer, a surface layer and an antifouling layer going upwards, the preparation method of the very thin electronic packaging leather comprises specifically the following steps:
S1: foundation fabric preparation:
Using a very thin woven fabric of terylene-elastane mixed dense plain woven butterfly mesh fabric, wherein terylene occupies a percentage of 75%-90% and elastane occupies a percentage of 10%-25%; preprocessing yarns by dyeing, washing and drying, weaving using a weaving machine, post-processing by forming and flattening and obtaining the foundation fabric layer;
S2: coating a surface layer sizing agent onto a surface of a release paper, heating, drying, and obtaining a surface layer of the packaging leather; coating an intermediate layer sizing agent over the surface layer, heating, drying and obtaining an intermediate layer of the packaging leather;
S3: laminating the foundation fabric layer and the intermediate layer via an adhesive layer;
Applying an adhesive layer sizing agent over the intermediate layer of the packaging leather, and applying the foundation fabric layer before drying;
S4: curing the applied foundation fabric layer into a 135° C. drying oven for 10-20 min, taking out, releasing and obtaining a PU/very thin woven fabric composite packaging leather;
S5: gravure printing an antifouling coating on a surface of the PU/very thin woven fabric composite packaging leather, wherein a coating amount is 20-30 g/m², drying and curing at a temperature of 170° C.±10° C. and obtaining the very thin electronic packaging leather product.

### Proportioning of the Sizing Agents in all the Layers are (in Weight Percentage)

| Surface layer | | Intermediate layer | | Adhesive layer | |
|---|---|---|---|---|---|
| Aqueous | 100 | Aqueous | 100 | Polyester | 100 |
| polyurethane | | polyurethane | | urethane | |
| surface layer | | intermediate | | (part A of | |
| resin: anionic | | layer resin: | | polyalcohol) | |
| aliphatic | | anionic | | | |
| aqueous | | aliphatic | | | |
| hydroxy-functional | | aqueous | | | |
| polyurethane | | polyurethane | | | |
| dispersion | | dispersion | | | |
| Defoaming | 0.01-0.2 | Defoaming | 0.01-0.2 | Dibutyltin | 0.1-1 |
| agent | | agent | | dilaurate | |
| Cross-linking | 0.1-3 | Cross-linking | 0.1-2 | esters | |
| agent | | agent | | Isocaprylic | 0.1-1 |
| Thickening | 0.1-3 | Thickening | 0.1-3 | acid | |
| agent | | agent | | bimuth | |
| Flattening | 0.1-2 | Coloring agent | 10-30 | Isocyanate- | 100-140 |
| agent | | | | capped | |
| Organic | 0.1-3 | | | polyurethane | |
| silicone wear | | | | prepolymer | |
| resistant | | | | (part B of | |
| feeling agent | | | | isocyanate) | |
| Coloring agent | 1-15 | | | Filling | 5-30 |
| | | | | agent | |
| Viscosity | 2000-10000 | Viscosity | 2000-10000 | Viscosity | 2000-10000 |
| cps/25° C. | | cps/25° C. | | cps/25° C. | |
| Coating | 100-300 | Coating | 100-300 | Coating | 100-300 |
| amount | | amount | | amount | |
| (g/m²) | | (g/m²) | | (g/m²) | |

### Proportioning of the Antifouling Coating is as Follows (in Weight Percentage):

Primary printing coating materials

| | | |
|---|---|---|
| Resin 1 | Organic silicone modified polyurethane | 100 |
| | resin | |
| Resin 2 | High silicon modified aqueous | 5-30 |
| | polyurethane resin | |
| Catalyst | Acid catalyst | 0.1-10 |
| Cross-linking | Isocyanate cross-linking agent | 0.1-5 |
| agent | | |

Secondary printing coating materials

| | | |
|---|---|---|
| Resin | Epoxy modified organic silicone resin | 100 |
| Catalyst | Platinum catalyst | 0.1-2 |
| Accelerating | Polymers, mainly silanol polymers | 0.1-5 |
| agent | | |

A viscosity of the antifouling coating is 600-800 cps/23° C.

By testing the very thin electronic packaging leather prepared as per the present invention, the test data are as follows:

| Test item | Result |
|---|---|
| Tensile load | Warp ≥100N/3 cm; weft ≥100N/3 cm |
| Elongation at break | Warp ≥5%; weft ≥5% |
| Tearing load | Warp ≥10N; weft ≥10N |
| Peeling load | Warp ≥30N/3 cm |
| Wear resistance | Alcohol abrasion 95% alcohol * 500 g * |
| | 100 times |
| | TABER wear resistance, H18, 500 g > |
| | 500 r |
| Pollution resistance | Wiping pen stains with a dry cloth, no |
| | taint is observed; wiping lipstick stains |
| | in 24 H constant temperature with |
| | alcohol, no taint is observed |
| Hydrolysis resistance | 120° C.*14 h water boiling, no foam |
| | formation or release is observed |
| Aging resistance at constant | 70° C.*95% RH, 95° C.*95% RH, no |
| temperature and constant | chalking, layering, foam formation or |
| humidity | release in five weeks is observed |

### Embodiment 1

A preparation method of a very thin electronic packaging leather, comprises the following steps:
S1: foundation fabric preparation:
Using a very thin woven fabric of terylene-elastane mixed dense plain woven butterfly mesh fabric, wherein terylene occupies a percentage of 75%, elastane occupies a percentage of 25%; preprocessing yarns by dyeing, washing, drying, weaving by using a weaving machine, post-processing by forming and flattening, and obtaining the foundation fabric layer;
S2: applying a surface layer sizing agent over a surface of a release paper, heating, drying, and obtaining a surface layer of the packaging leather; coating an intermediate layer sizing agent over the surface layer, heating, drying and obtaining an intermediate layer of the packaging leather; S3: laminating the foundation fabric layer with the intermediate layer via an adhesive layer;
Coating an adhesive layer sizing agent over the intermediate layer of the packaging leather, and closing the foundation fabric layer before drying;
S4: putting the foundation fabric layer together with the release paper into a 135° C. drying oven, curing for 10-20 min, taking out, releasing the foundation fabric layer, and obtaining a PU/very thin woven fabric composite packaging leather;
S5: gravure printing an antifouling coating on a surface of the PU/very thin woven cloth composite packaging leather, with a coating amount of 20-30 g/m²; drying and curing at a temperature of 170° C.±10° C., forming the antifouling layer, and obtaining a very thin electronic packaging leather product.

The foundation fabric layer is selected from: terylene+elastane (30D+20D*30D+20D), wherein terylene occupies a percentage of 85%, elastane occupies a percentage of 15%, and the foundation fabric weighs 45 gsm, having a thickness of 0.09 mm.

Proportioning of the surface layer sizing agent: anionic aliphatic aqueous hydroxy-functional polyurethane dispersions (solid content 40%) 100 parts, defoaming agent 0.01 part, cross-linking agent 1 part, thickening agent 1 part, flatting agent 0.5 part, organic silicone wear resistant feeling agent 1 part, black waterborne color sizing 5 parts, wherein a viscosity of the surface layer sizing agent is 5000 cps/25° C. and a coating amount is 200 g/m²;
Proportioning of the intermediate layer sizing agent: anionic aliphatic aqueous polyurethane dispersions (solid content 45%) 100 parts, defoaming agent 0.1 part, flatting agent 0.5 part, thickening agent 1 part, black waterborne coloring sizing 15 parts, wherein a viscosity of the intermediate layer sizing agent is 5000 cps/25° C. and a coating amount is 200 g/m²;
Proportioning of the agent of the adhesive layer: polyether urethane 100 parts, dibutyltin dilaurate esters 0.5 part, isocaprylic acid bismuth 0.5 part, matting powder 10 parts, isocyanate-capped polyurethane prepolymers 120 parts, with a viscosity of 5000 cps/25° C. and a coating amount of 200 g/m².

Proportioning of the antifouling coating: organic silicone modified polyurethane resin (solid content 30%) 100 parts, high-silicon modified aqueous polyurethane resin 15 parts, acid catalysts 2 parts, isocyanate cross-linking agent 2 part; and a viscosity of the antifouling agent is 700 cps/23° C. and a coating amount is 25 g/m².

### Embodiment 2

A preparation method of a very thin electronic packaging leather, wherein the preparation steps are the same as those in embodiment 1, and differences lie in:
The foundation fabric layer is selected from: terylene+elastane (20D+15D*20D+15D), wherein terylene occupies a percentage of 80%, elastane occupies a percentage of 20%, and the foundation fabric weighs 50 gsm, having a thickness of 0.085 mm.

Proportioning of the surface layer sizing agent: anionic aliphatic aqueous hydroxy-functional polyurethane dispersions (solid content 40%) 100 parts, defoaming agent 0.15 part, cross-linking agent 2 parts, thickening agent 2 parts, flatting agent 1 part, organic silicone wear resistant feeling agent 2 parts, white waterborne color sizing 10 parts, wherein a viscosity of the surface layer sizing agent is 6000 cps/25° C. and a coating amount is 250 g/m²;
Proportioning of the intermediate layer sizing agent: anionic aliphatic aqueous polyurethane dispersions (solid content 45%) 100 parts, defoaming agent 0.15 part, flatting agent 1 part, thickening agent 2 parts, white waterborne coloring sizing 20 parts, wherein a viscosity of the intermediate layer sizing agent is 6000 cps/25° C. and a coating amount is 250 g/m²;
Proportioning of the agent of the adhesive layer: polyether urethane 100 parts, dibutyltin dilaurate esters 0.8 part, isocaprylic acid bismuth 0.8 part, aluminium hydroxide 15 parts, isocyanate-capped polyurethane prepolymers 130 parts, with a viscosity of 6000 cps/25° C. and a coating amount of 250 g/m².

### Embodiment 3

A preparation method of a very thin electronic packaging leather, wherein the preparation steps are the same as those in embodiment 1, and differences lie in:
The foundation fabric layer is selected from: terylene+elastane (30D+20D*30D+20D), wherein terylene occupies a percentage of 90%, elastane occupies a percentage of 10%, and the foundation fabric weighs 55 gsm, having a thickness of 0.095 mm.

Proportioning of the surface layer sizing agent: anionic aliphatic aqueous hydroxy-functional polyurethane dispersions (solid content 40%) 100 parts, defoaming agent 0.2 part, cross-linking agent 3 parts, thickening agent 3 parts, flatting agent 2 part, organic silicone wear resistant feeling agent 3 parts, blue waterborne color sizing 15 parts, wherein a viscosity of the surface layer sizing agent is 8000 cps/25° C. and a coating amount is 300 g/m²;
Proportioning of the intermediate layer sizing agent: anionic aliphatic aqueous polyurethane dispersions (solid content 45%) 100 parts, defoaming agent 0.2 part, flatting agent 2 parts, thickening agent 3 parts, blue waterborne coloring sizing 20 parts, wherein a viscosity of the intermediate layer sizing agent is 8000 cps/25° C. and a coating amount is 300 g/m²;
Proportioning of the agent of the adhesive layer: polyether urethane 100 parts, dibutyltin dilaurate esters 1 part, isocaprylic acid bismuth 1 part, glass microspheres 20 parts, isocyanate-capped polyurethane prepolymers 140 parts, with a viscosity of 8000 cps/25° C. and a coating amount of 300 g/m².

### Embodiment 4

Using the technical solution in embodiment 3, but the antifouling coating has two layers, specifically:
S5: gravure printing the antifouling coating on the surface of the PU/very thin woven fabric laminated material packaging leather, a coating amount is 25 g/m², curing at a temperature of 170° C.±10° C. to form a first layer of the antifouling coating, and gravure printing a second layer of antifouling coating on a surface of the first layer of antifouling coating, a coating amount is 20-30 g/m², drying and curing at a temperature of 170° C.±10° C. to form a second layer of antifouling coating and obtaining the very thin electronic packaging leather product.

Proportioning of the first layer of the antifouling coating: organic silicone modified polyurethane resin (solid content 30%) 100 parts, high-silicon modified aqueous polyurethane resin 15 parts, acid catalyst 2 parts, and isocyanate cross-linking agent 2 parts; a viscosity of the antifouling coating is 700 cps/23° C. and a coating amount is 25 g/m²;
Proportioning of a second layer of the antifouling coating:
epoxy-modified organic silicone resin 100 parts, platinum catalysts 0.5 part, accelerating agents 2 parts, propanediol 20 part, and a viscosity of the antifouling coating is 700 cps/23° C. and a coating amount is 25 g/m².

### Comparative Example 1

Using the technical solution in embodiment, but the antifouling coating is not applied.

### Comparative Example 2

Using the technical solution in embodiment 2, but the aqueous polyurethane resin in the surface layer and the intermediate layer is replaced with the conventional solvent polyurethane resin.

### Comparative Example 3

Using the technical solution in embodiment 3, but a woven fabric with a common thickness of 0.3 mm is used for the foundation fabric.

### Performance Test

Performance test results of the embodiments and the comparative example were shown in Table 1. Measuring of the peeling strength is before coating the antifouling coating, and the packaging leather surface is smooth and not sticky.

| | Embo. | Embo. | Embo. | Embo. | Comp. | Comp. | Comp. |
|---|---|---|---|---|---|---|---|
| Test item | 1 | 2 | 3 | 4 | 1 | 2 | 3 |
| Thickness (mm) | 0.18 | 0.20 | 0.23 | 0.23 | 0.17 | 0.21 | 0.45 |
| Longitudinal | 300 | 320 | 330 | 335 | 300 | 310 | 320 |
| tensile load | | | | | | | |
| (N/3 cm) | | | | | | | |
| Latitudinal | 180 | 220 | 225 | 230 | 175 | 185 | 180 |
| tensile load | | | | | | | |
| (N/3 cm) | | | | | | | |
| Longitudinal | 64 | 70 | 68 | 71 | 62 | 72 | 70 |
| elongation at | | | | | | | |
| break (%) | | | | | | | |
| Latitudinal | 85 | 95 | 90 | 89 | 80 | 105 | 100 |
| elongation at | | | | | | | |
| break (%) | | | | | | | |
| Longitudinal | 12 | 13 | 14 | 13 | 11 | 10 | 9.9 |
| tearing strength | | | | | | | |
| (N/cm) | | | | | | | |
| Latitudinal | 10 | 11 | 12.5 | 11 | 9.8 | 7.7 | 7.9 |
| tearing strength | | | | | | | |
| (N/cm) | | | | | | | |
| Longitudinal | 61 | 64 | 75 | 68 | 58 | 60 | 78 |
| peeling strength | | | | | | | |
| (N/3 cm) | | | | | | | |
| TABER wear | 30000 | 35000 | 60000 | 100000 | 8000 | 55000 | 65000 |
| resistance (time) | | | | | | | |
| Pollution | 4 | 4 | 4 | 5 | 2 | 4 | 4 |
| resistance | | | | | | | |
| (grade) | | | | | | | |
| VOC release | <50 | <50 | <50 | <50 | <50 | >500 | <50 |
| (mg/m²) | | | | | | | |

From the foregoing test results, it can be known that:
1. In the three embodiments of the present invention, ideal very thin electronic packaging leathers are obtained, the product thickness is less than 0.25 mm, and good physical performance is maintained. In comparison, in the comparative example 3, the common thickness foundation fabric was used, finally, the product thickness reached 0.45 mm, which is not appropriate for use as a very thin electronic packaging leather.
2. For all of the embodiments 1-3, excellent antifouling performance is achieved, whereas, for the comparative example 1, as no antifouling coating was provided, the pollution resistant performance was significantly deteriorated (2 grades). This establishes that, the antifouling coating in the present invention has a significant role in improving the pollution resistant performance of the product.
3. In the embodiments 1-3, the VOC release amounts were less than 50 mg/m², however, in the comparative example 2, due to the use of the conventional solvent polyurethane resin, the VOC release amount exceeds 500 mg/m², which is not acceptable according to environment protection requirements. This establishes that, the aqueous polyurethane system used in the present invention has significant environment protection advantages.
4. In view of wear resistance and aging resistance, all of the three embodiments performed well, wherein the performance of the embodiment 3 was the best, which was correlated to the high usage amount of the cross-linking agent.
5. In comprehensive view of all the performance indicators, embodiment 3 and embodiment 4 had the best performance, in the embodiment 4, as the antifouling coating had two layers, better antifouling performance was achieved, which resulted from the optimized proportioning, including higher surface layer and intermediate layer coating amount, and the better antifouling coating proportioning.

The test results proves that, the preparation method of the very thin electronic packaging leather is not only very thin, has maintained excellent physical properties, and has outstanding environment friendliness and pollution resistance, which satisfies requirements of modern electronic products on packaging materials.

In the present specification, the embodiments are described in a way of progression, and what is emphasized in the description of the embodiments are the differences with the other embodiments, for the same or similar parts please refer to the description in the other embodiments. The apparatus disclosed in the embodiments corresponds to the method disclosed in the embodiment, therefore the description of the apparatus is simple, and for the corresponding part please refer to the description of the method embodiments.

The foregoing is a detailed description of the very thin electronic packaging leather and preparation method thereof. In the present invention, the principle and embodiments of the present invention are described by giving some instances, and the description of the embodiments are intend to help understanding the method and the core idea of the present invention. It shall be pointed out that, for those of ordinary skill in the art, without departing from the principle of the present invention, it is still possible to make modifications and improvements to the present invention and such modifications and improvements fall into the protection scope of the present invention.

1. A preparation method of very thin electronic packaging leather, the method comprises the following steps:
S1: foundation fabric preparation: using terylene-elastane mixed dense plain woven butterfly mesh fabric as a foundation fabric layer, wherein terylene having a weight percentage of 75%-90% and elastane having a weight percentage of 10%-25%;
S2: coating a surface layer sizing agent on a surface of a release paper, heating, drying, and obtaining a surface layer of the packaging leather; coating an intermediate layer sizing agent over the surface layer, heating, drying, and obtaining an intermediate layer of the packaging leather;
S3: laminating the foundation fabric layer with the intermediate layer via an adhesive layer;
applying an agent of the adhesive layer on the intermediate layer of the packaging leather, and attaching the foundation fabric layer before the agent is dried;
S4: curing the foundation fabric layer and the release paper in a 135° C. drying oven for 10-20 min, taking out, releasing and obtaining a PU/very thin woven fabric laminated material packaging leather;
S5: gravure printing antifouling coating on a surface of the PU/very thin woven fabric laminated material packaging leather, a coating amount is 20-30 g/m², drying and curing at a temperature of 170° C.±10° C. to form an antifouling coating, and obtaining a very thin electronic packaging leather product.

2. The preparation method of very thin electronic packaging leather according to claim 1, wherein the very thin woven fabric comprises a specification of terylene and elastane (30D+20D*30D+20D) or (20D+15D*20D+15D), weight 40-60 gsm, and thickness 0.08-0.1 mm; a thickness of the very thin electronic packaging leather product is 0.15-0.25 mm.

3. The preparation method of very thin electronic packaging leather according to claim 1, wherein the surface layer sizing agent comprises following elements in parts by weight: anionic aliphatic aqueous hydroxy-functional polyurethane dispersions 100 parts, a defoaming agent 0.01-0.2 parts, a cross-linking agent 0.1-3 parts, a thickening agent 0.1-3 parts, a flatting agent 0.1-2 parts, an organic silicone wear resistant feeling agent 0.1-3 parts, color sizing 1-15 parts, wherein a solid content of the anionic aliphatic aqueous hydroxy-functional polyurethane dispersions is 35-45%, a viscosity of the surface layer sizing agent is 1000-10000 cps/25° C. and a coating amount is 100-300 g/m²;
preparation of the surface layer sizing agent: adding the organic silicone wear resistant feeling agent, the flatting agent and the color sizing into the anionic aliphatic aqueous hydroxyl-functional polyurethane dispersions, stirring, adding the defoaming agent, adding the thickening agent to adjust to an appropriate viscosity, stirring to disperse uniformly, adding the cross-linking agent before fabrication, stirring gently, filtering and vacuum defoaming.

4. The preparation method of very thin electronic packaging leather according to claim 1, wherein the intermediate layer sizing agent comprises the following elements in parts by weight: anionic aliphatic aqueous polyurethane dispersions 100 parts, a defoaming agent 0.01-0.2 parts, a flatting agent 0.1-2 parts, a thickening agent 0.1-3 parts, coloring sizing 10-30 parts, wherein a solid content of the anionic aliphatic aqueous polyurethane dispersions is 30-60%, a viscosity of the intermediate layer sizing agent is 1000-10000 cps/25° C. and a coating amount is 100-300 g/m²;
preparation of the intermediate layer sizing agent: adding the flatting agent and the color sizing in the anionic aliphatic aqueous polyurethane dispersions, stirring, adding the defoaming agent, dispersing completely, adding the thickening agent to adjust to an appropriate viscosity, filtering and vacuum defoaming.

5. The preparation method of very thin electronic packaging leather according to claim 1, wherein the agent of the adhesive layer comprises the following elements in parts by weight: polyether urethane 100 parts, dibutyltin dilaurate esters 0.1-1 parts, isocaprylic acid bismuth 0.1-1 parts, isocyanate-capped polyurethane prepolymers 100-140 parts, filling agents 5-30 parts, with a viscosity of 2000-10000 cps/25° C. and a coating amount of 100-300 g/m²; the filling agent is selected from any one or two or combination of matting powder, aluminum hydroxide, aluminum oxide, magnesium hydroxide, zinc borate, aluminum silicate, magnesium carbonate, glass microspheres, white carbon black, silicone resin powder, silicon dioxide, calcium carbonate or magnesium oxide;
preparation of the agent of the adhesive layer: taking the polyether urethane 100 parts, adding the filling agent, the dibutyltin dilaurate esters and the isocaprylic acid bismuth, stirring evenly, and obtaining a solvent free adhesive layer resin; mixing the polyether urethane and the isocyanate-capped polyurethane prepolymers, stirring quickly and obtaining the agent of the adhesive layer.

6. The preparation method of very thin electronic packaging leather according to claim 1, wherein the antifouling coating comprises the following elements in parts by weight: organic silicone modified polyurethane resin 100 parts, high-silicon modified aqueous polyurethane resin 5-30 parts, acid catalysts 0.1-10 parts, isocyanate cross-linking agents 0.1-5 part; and a viscosity of the antifouling coating is 600-800 cps/23° C.

7. The preparation method of very thin electronic packaging leather according to claim 1, wherein in the antifouling coating, platinum catalyst is selected from any one or combination of platinic chloride-divinyl-tetramethyldisiloxane composition, platinic chloride-1,3,5,7-tetravinyl-1,3,5,7-tetramethyl-cyclotetrasiloxane, or divinyl-tetramethyldisiloxane, and a Pt (platinum) atom content in the platinum catalyst is 300-100000 ppm.

8. The preparation method of very thin electronic packaging leather according to claim 1, wherein S5: gravure printing the antifouling coating on the surface of the PU/very thin woven fabric laminated material packaging leather, wherein
a first layer of the antifouling coating comprises the following components in parts by weight: organic silicone modified polyurethane resin 100 parts, high-silicon modified aqueous polyurethane resin 5-30 parts, acid catalyst 0.1-10 parts, and isocyanate cross-linking agent 0.1-5 parts; a viscosity of the antifouling coating is 600-800 cps/23° C.;
a second layer of the antifouling coating comprises the following components in parts by weight: epoxy-modified organic silicone resin 100 parts, platinum catalysts 0.1-2 parts, and accelerating agents 0.1-5 parts and a viscosity of the antifouling coating is 600-800 cps/23° C.

9. The preparation method of very thin electronic packaging leather according to claim 1, wherein
the first layer of the antifouling coating comprises the following components in parts by weight: organic silicone modified polyurethane resin (a solid content of 3%) 100 parts, high-silicon modified aqueous polyurethane resin 15 parts, acid catalyst 2 parts, and isocyanate cross-linking agent 2 parts, adjusting the viscosity to 700 cps/23° C. and a coating amount of 25 g/m²;
the second layer of the antifouling coating comprises the following components in parts by weight: epoxy-modified organic silicone resin 100 parts, platinum catalysts 0.5 parts, accelerating agents 2 parts, and propanediol 20 parts, adjusting the viscosity to 700 cps/23° C. and a coating amount of 25 g/m².

10. A very thin electronic packaging leather obtained by using the preparation method of very thin electronic packaging leather according to claim 1, wherein, wherein the very thin electronic packaging leather comprises a foundation fabric layer, an adhesive layer, an intermediate layer, a surface layer and an antifouling coating.
